(19) United States
(12) Patent Application Publication
(10) Pub. No.: US 2014/0225692 A1
(43) Pub. Date: Aug. 14, 2014

(54) ATTRACTION PLATE STRUCTURE OF ELECTROMAGNETIC DOORLOCK

(71) Applicant: YI-FAN LIAO, TAOYUAN COUNTY (TW)

(72) Inventor: YI-FAN LIAO, TAOYUAN COUNTY (TW)

(21) Appl. No.: 14/161,846

(22) Filed: Jan. 23, 2014

(30) Foreign Application Priority Data
Feb. 8, 2013 (TW) 102105133

(51) Int. Cl. H01F 7/16

(52) U.S. Cl. CPC H01F 7/1638
USPC 335/279

(57) ABSTRACT

An attraction plate structure of electromagnetic doorlock comprises an attraction plate positioned on a mounted body by a positioning assembly. The attraction surface has an arch portion higher than the bottom plane of 0.04 mm to 0.27 mm at a central region thereof, and the arch portion extends towards both ends to form an arc surface, so that a convex-curve surface is formed with both ends lower than the central region. The present invention uses the convex curve design of the attraction surface to produce the curved internal stress while the attraction plate is pulled. Due to the curved internal stress, the electric magnet under the normal current is able to enhance the tensile value of the electromagnetic doorlock, saving energy and enhancing the security access control.

### BACKGROUND OF THE INVENTION

1. Field of the Invention

The invention relates to an attraction plate structure of electromagnetic doorlock, particularly to an attraction surface of the attraction plate being a convex-curve surface structure to form a curved internal stress.

2. Description of the Related Art

In the access control monitoring system, the use of an electromagnetic doorlock has been very popular. The electromagnetic doorlock 10 as shown in FIG. 1 provides an electric magnet 11 mounted on a door flame 15 and an attraction plate 12 mounted on a corresponding position of a door plate 14. When the electric magnet 11 is energized to produce electromagnetic attraction and attract the attraction plate 12, the electromagnetic doorlock 10 forms in a lock state. When the electric magnet 11 is de-energized and the attraction plate 12 detaches from the electric magnet 11, the electromagnetic door lock 10 then forms in an unlock state.

The traditional attraction plate 12 as FIGS. 2 to 4 comprises an attraction surface 121 in a flat shape, and one or two positioning holes 122. The attraction plate 12 is fixed on a mounted body 13 by a screw 123 and other related accessories 124. The mounted body 13 as shown in FIG. 2 is in a box shape. With the reference to FIG. 1A, the mounted body 13 has a plurality of fixed holes 125 for fixed to the door plate 14 by a plurality screws 126, but it is not a limitation. basically, the mounted body 13 can be set for any shapes or the door plate 14 directly can be as a mounted body 13 to fix the attraction plate 12 by the screw 123 and other related accessories 124 as shown in FIG. 1B. No matter what shape of the mounted body 13 is, the combination method of the mounted body 13 and attraction plate 12 is the same, and the attraction surface 121 is a plat surface. For example, the U.S. Pat. No. 4,487,439 discloses a screw and a positioning hole, and the U.S. Pat. No. 4,652,028 discloses tow screws and two positioning holes.

This kind of structure of the attraction surface 121 is used for many years. After continuous research, the inventor found out that after the electric magnet 11 is energized, the magnetic flux density (B) is strong in the region of both ends, and the magnetic flux density (B) is weak in the middle region. Thus, as shown in FIGS. 4 and 5A, 5B, when the door plate 144 is pulled, the action force (F) is focus on the screw 123 in the middle, and the electric plate 12 is pulled by the screw, 123. At this time, the middle region of the electric plate 12 is curved and deformed like a dotted line (C) as shown in FIG. 5B, and the curvature and deformation will affect the attraction effect at both sides of the electric plate 12. That is, when the region of the electric plate 12 is curved and deformed, the attraction surface 121 will departed from the electric magnet 11. The experimental result shows that when the electric magnet is subjected to 500 mA current and 12V voltage, the electric magnet with strength of 185 mm and thickness of 15 mm is easily to be pulled away from the attraction plate as the tension value is between 400 to 500 pounds. The industry claimed that the tension value can reach to 600 pounds, but the attraction plate is pulled with less than 500 pounds. Therefore, to increase the attraction force of the attraction plate 12 of the conventional electromagnetic doorlock, the current of the electric magnet 11 or the attraction area of the electric magnet and attraction plate should be increased, forming a waste of energy or increasing the materials and transportation costs. Accordingly, there is room for improvement of the structure of conventional attraction plate 12.

### SUMMARY OF THE INVENTION

It is the main object of the present invention to provide an attraction plate structure of electromagnetic doorlock so that under the unchanged current of the electric magnet or unchanged attraction area between the electric magnet and attraction plate, the tension value is increased more than 10% to save energy and enhance the security access control.

In order to achieve the above objects, the attraction plate structure of electromagnetic doorlock comprises an electric magnet; an attraction plate in a long shape, having an attraction surface, the attraction surface arranged at a corresponding surface of the electric magnet, and the attraction plate positioned on a mounted body by a positioning assembly; wherein the attraction surface has an arch portion higher than the bottom plane of 0.04 mm to 0.27 mm at a central region thereof, and the arch portion extends towards both ends to form a curve surface, so that a convex-curve surface is formed with both ends lower than the central region;

Whereby when the attraction plate is attracted by the magnetic force produced by the electric magnet, the convex-curve surface is forced to deform for abutting the electric magnet; when the mounted body is pulled in an opposite direction of the electric magnet, the attraction plate under the tension of the positioning assembly overcomes the curved internal stress of the attraction plate to enhance the tensile value of the attraction plate.

Base on the features disclosed, the present invention uses the convex curve design of the attraction surface to produce the curved internal stress while the attraction plate is pulled. Due to the curved internal stress, the electric magnet under the normal current is able to enhance the tensile value of the electromagnetic doorlock, saving energy and enhancing the security access control.

### BRIEF DESCRIPTION OF THE DRAWINGS

FIG. 1 is a schematic view of a conventional electromagnetic doorlock;

FIG. 1A is an exploded perspective view of the mounted body of the conventional electromagnetic doorlock;

FIG. 1B is another exploded perspective view of the mounted body of the conventional electromagnetic doorlock;

FIG. 2 is a perspective view of the separation of the conventional electromagnetic doorlock;

FIG. 3 is a perspective view of the attraction state of the conventional electromagnetic doorlock;

FIG. 4 is an exploded view of the attraction state of the conventional electromagnetic doorlock;

FIG. 5A is a distribution diagram of an attraction force of an attraction plate of the conventional electromagnetic doorlock;

FIG. 5B is a deformation diagram of a tensile force of an attraction plate of the conventional electromagnetic doorlock;

FIG. 6 is an exploded perspective view of the preferred embodiment in accordance with the present invention;

FIG. 7 is an assembly perspective view of the preferred embodiment in accordance with the present invention;

FIG. 8 is an assembly exploded view of the preferred embodiment in accordance with the present invention;

FIG. 9 is an exploded perspective view of the preferred embodiment in accordance with the present invention;

FIG. 10 is an exploded view of the attraction plate structure in accordance with the present invention;

FIG. 11 is a partially enlargement view of FIG. 10;

FIG. 12 is a distribution diagram of an attraction force of the attraction plate in accordance with the present invention;

FIG. 12A is comparison view between FIG. 12 of the present invention and FIG. 5A of the prior art;

FIG. 13 is a deformation diagram of a tensile force of the attraction plate in accordance with the present invention; and

FIG. 14 is a curved diagram of the tensile test of the present invention.

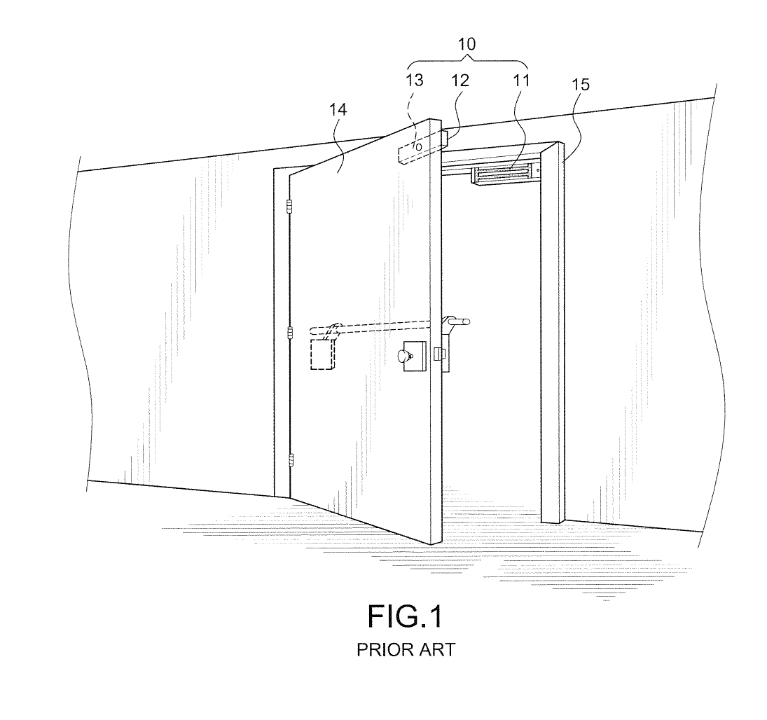

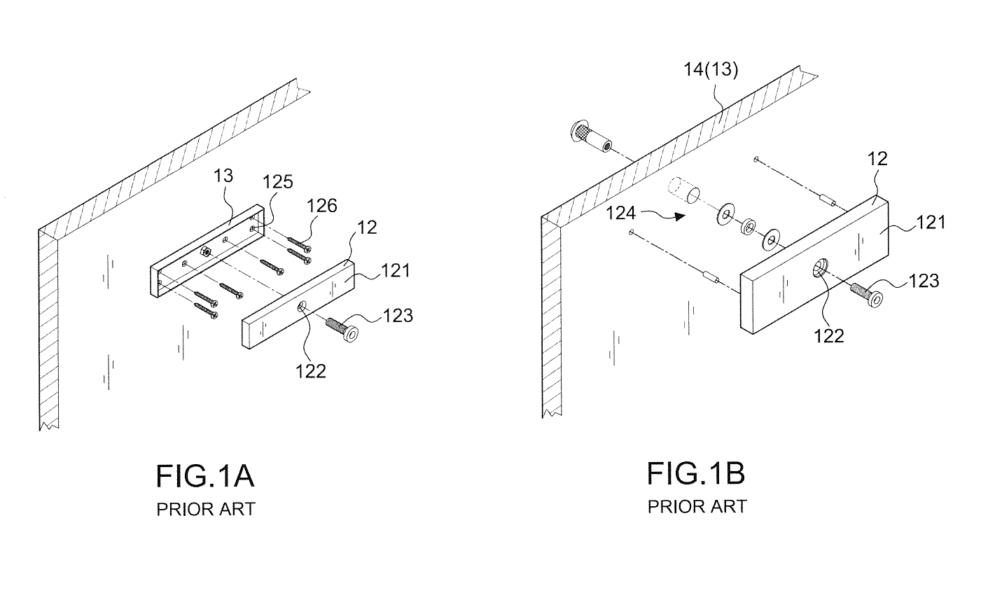

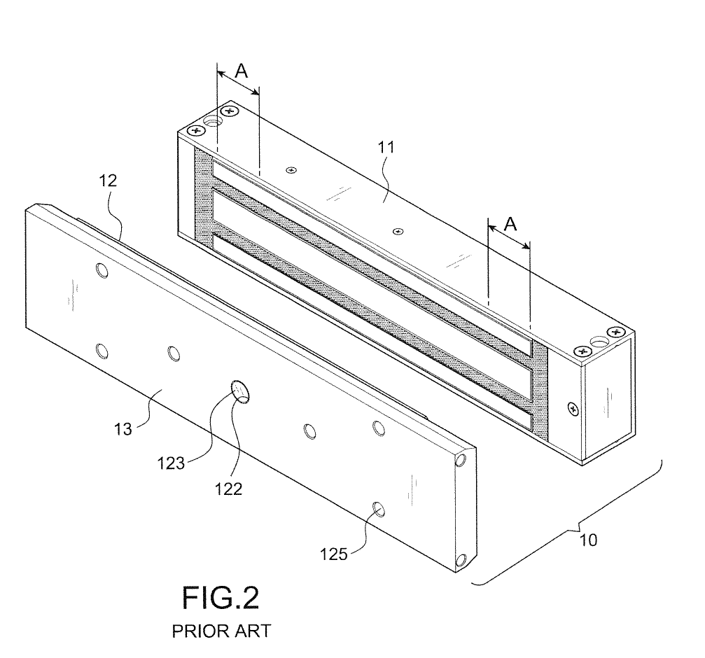

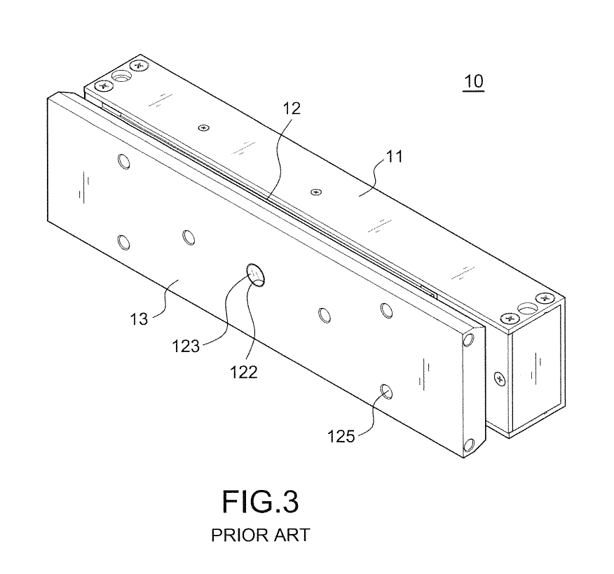

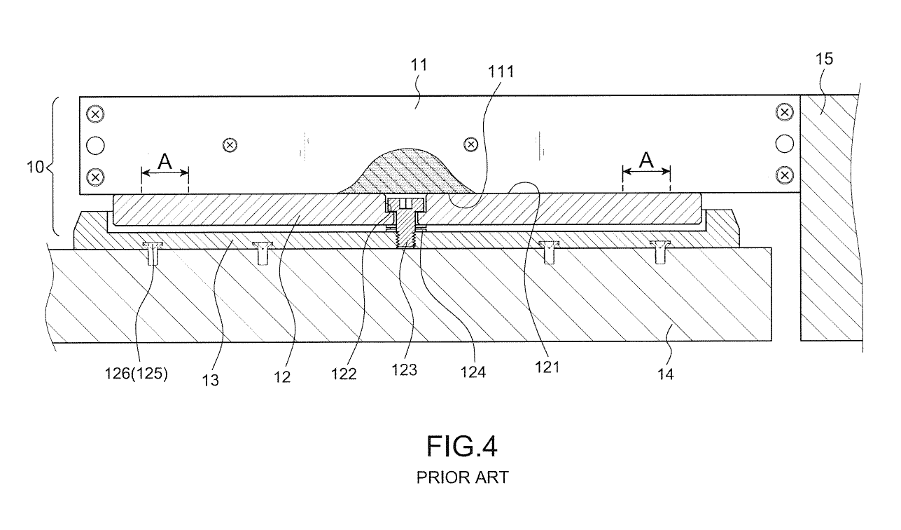

### DETAILED DESCRIPTION OF THE PREFERRED EMBODIMENT

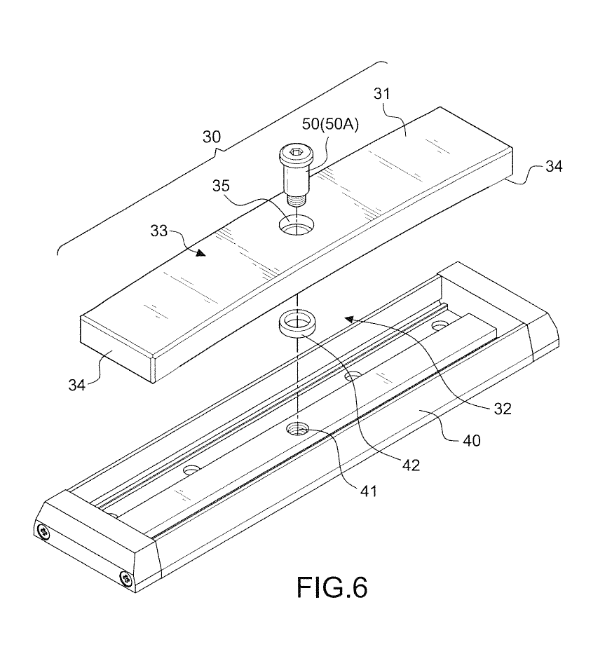

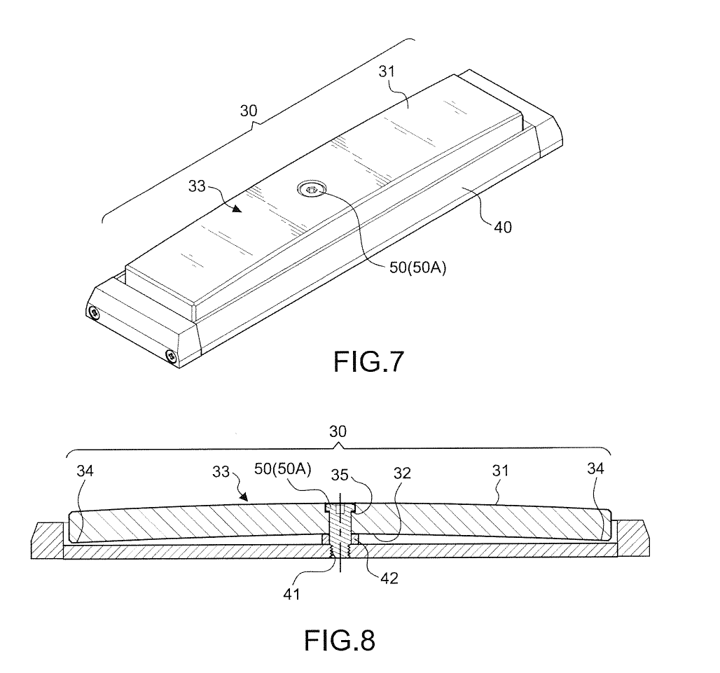

With the referenced to FIGS. 6 through 14, an electromagnetic doorlock 60 of the preferred embodiment in accordance with the present invention comprises an electric magnet 20, and an attraction plate 30 in a long shape having an attraction surface 31. The attraction surface 31 is arranged at a corresponding surface of the electric magnet 20, and the attraction plate 30 is positioned on a mounted body 40 by a positioning assembly 50.

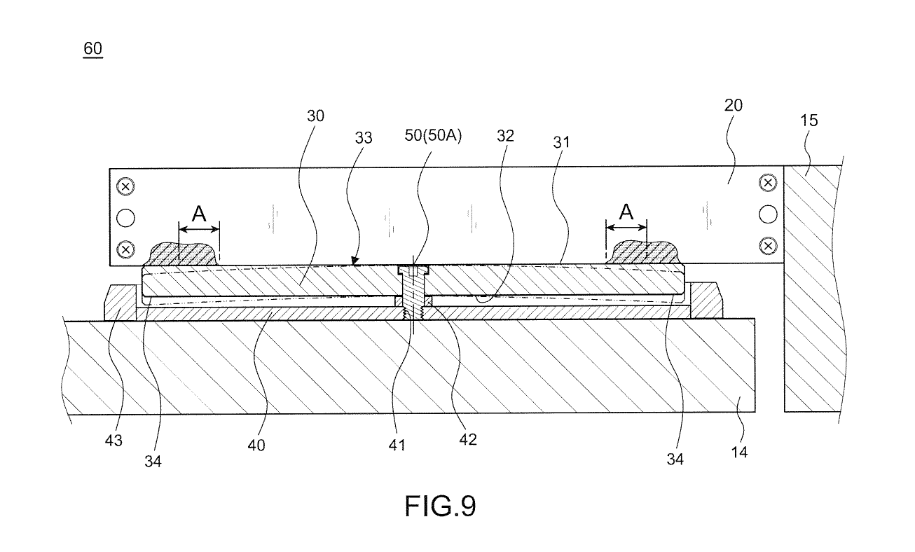

FIG. 9 is a sectional view of the attraction status of the electric magnet 20 and attraction plate 30 in accordance with the present invention; wherein the electric magnet 20 is fixed to a door flame 15, and the attraction plate 30 is mounted on the mounted body 40 which is fixed to a door plate 14. The electromagnetic doorlock 60 in the embodiment basically has the same mounted method with an electromagnetic door lock 10 of prior art, and thus will not be described in details here. Also, the electric magnet 20 is not the main feature of the present invention and thus will not be described in details here. Besides, the mounted body 40 disclosed in the present invention not limited to the following shapes can be any shapes as required, or the door plate 14 directly as the mounted body 40 is provided for positioning the attraction plate 30.

The structure design of the attraction plate 30 is the main feature of the present invention. With the reference to FIGS. 9 to 13, the important feature of the present invention is that the attraction plate 30 is in an arch structure opposite to the actuation position of a tensile force F of the attraction plate 30. That is, the attraction plate 30 has middle region positioned to the mounted body 40 by the positioning assembly 50, and the attraction surface 31 is a convex-curve surface 33.

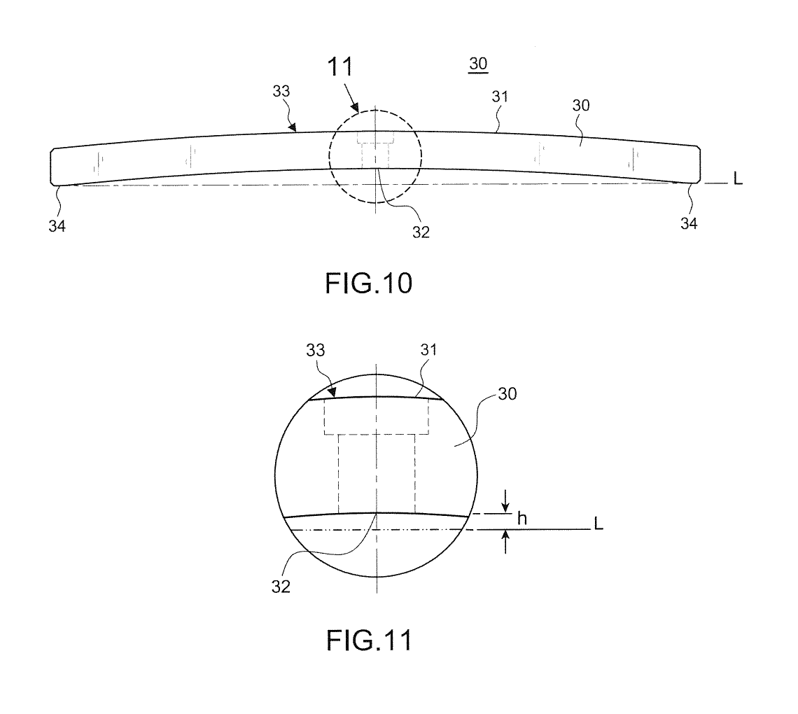

With the reference to FIGS. 10 and 11, the convex-curve surface 33 higher the bottom plane L has a height h, and the height h being a relative high point at the middle of an arch portion 32 extends towards both ends 34 to form an arc surface. The bottom plane L here refers to a virtual straight line, a line for pulling from the lowest position of both ends 34 of the attraction plate 30. The forming of the convex-curve surface 33 includes bending, shaping, punching, planning and milling, and other processing methods. Whereby when the attraction plate 30 is contacted to the electric magnet 20, the attraction plate 30 with a curved internal stress is attracted by the magnetic force of the electric magnet 20, and forced to deform rapidly for abutting the electric magnet 20 as shown in FIG. 9.

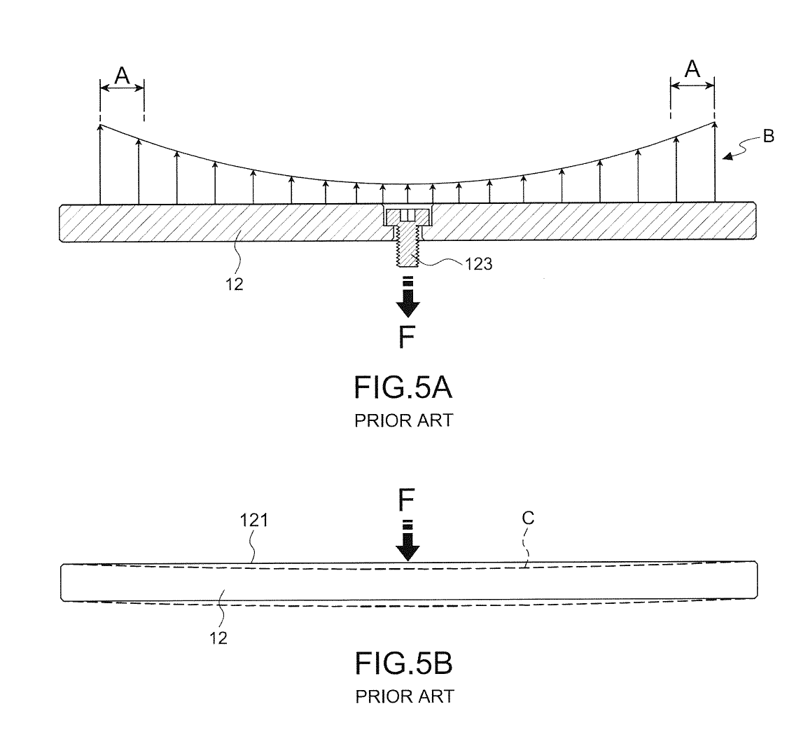

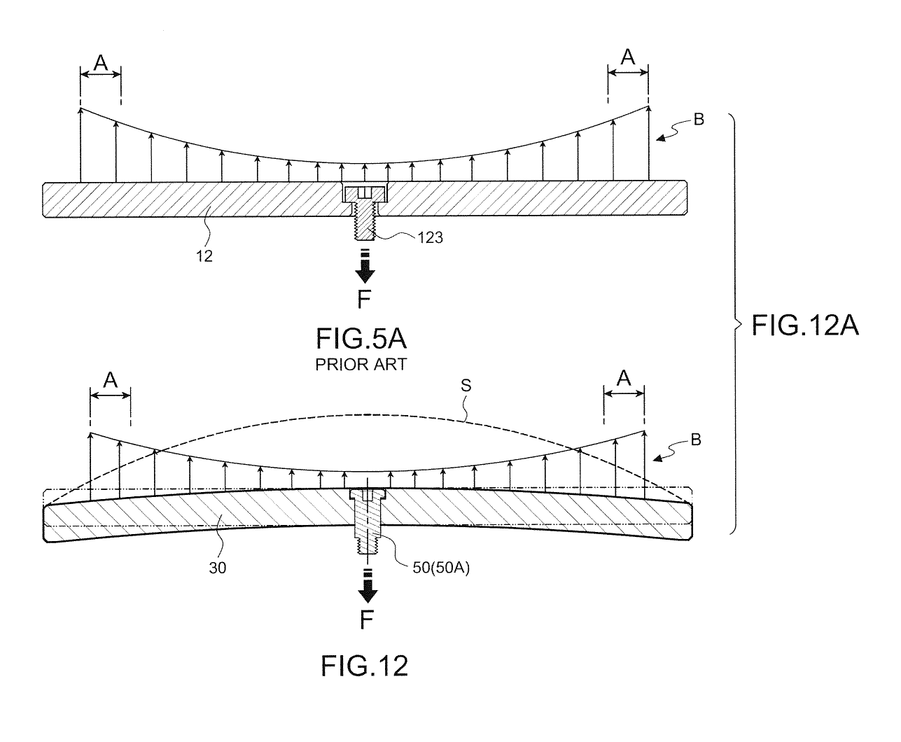

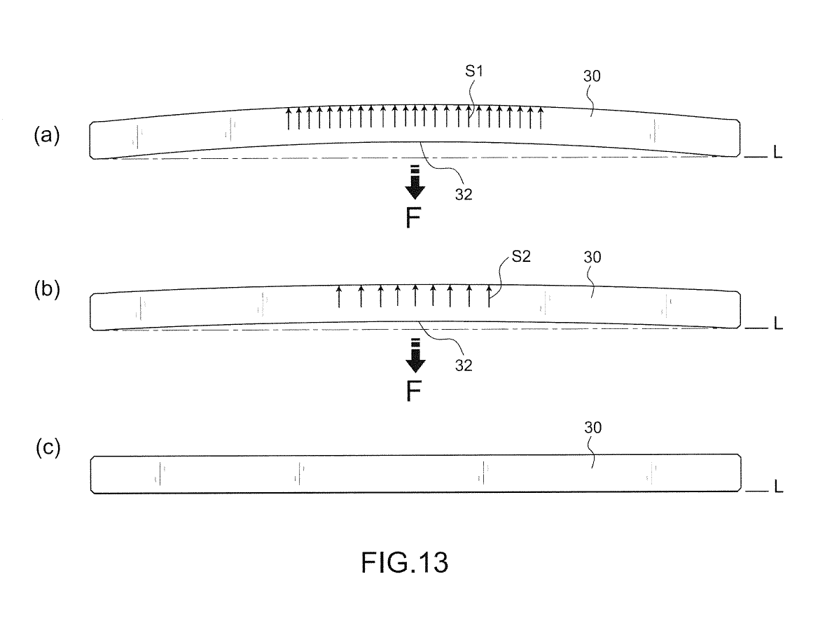

FIG. 12 is a distribution diagram of the magnetic flux density B of the electric magnet 20 for the attraction plate 30, and the reason for the magnetic flux density distribution is explained in the prior art and thus will not be described here. FIG. 12A is comparison view between FIG. 12 of the present invention and FIG. 5A of the prior art, and FIG. 13 is a schematic view, showing that the attraction plate 30 is not horizontal, and the change of the convex-curve surface 33 by enlarging the deformation curve to indicate that the tensile force is increased by the curved internal stress.

The experiment proved that the height h of the convex-curve surface 33 between 0.04 mm˜0.27 mm can play a larger effect. If the height h of the convex-curve surface 33 is too high, the curved internal stress will be too large to offset the attraction force of the electric magnet 20, and then decrease the tensile force. From the material mechanics point of view, the attraction plate 30 is like a “ [symbol] ”-shaped beam, and both ends are positions with stronger magnetic flux density B; thus, when the attraction plate 30 is pulled away from the electric magnet 20, the present invention not only overcomes the magnetic force of the electric magnet 20 but overcomes the curved internal stress S produced by the “ [symbol] ”-shaped attraction plate 30 as shown in FIG. 12. The curved internal stress Si as shown in FIG. 13 gradually changes in sequence from figure (a), (b) to (c). The figure (a) shows strong curved internal stress S1 at middle of the attraction plate 30, and then the strong curved internal stress S1 gradually becomes weak curved internal stress S2 as shown in figure (b) for the tensile force F is increased. Finally, the tensile force F continually increases to the state as shown in the figure (c), so that the attraction plate 30 can be pulled away from the electric magnet 20. Therefore, the magnetic flux density B is weak in the middle region of the conventional electric magnet 20 so that the attraction plate 30 is easy to be pulled away from the electric magnet 20. In contrast, before overcoming the magnetic force as shown in FIG. 12, the electric magnet 20 should overcomes the curved internal stress S produced by the “ [symbol] ”-shaped attraction plate 30 in the middle, and this curved internal stress S just offsets the tensile force which has weak magnetic flux density B at the middle of the attraction plate 30. Accordingly, in the case of the constant input current of the electric magnet 20, the electromagnetic doorlock 60 of the present invention can increase the tension value by more than 10%.

In principle, as long as the positioning assembly 50 is able to pull the middle of the attraction plate 30, the type of the positioning assembly 50 is not a limitation. The mounted body 40 may include a box-like body, U-shaped body, L-shaped body, or flat body. The above components can also be embedded in the door, or the door is directly the mounted body 40. An applicable embodiment as shown in FIGS. 6 to 9 is described below.

In the embodiment, the mounted body 40 being a box-like body has a positioning hole 41 in a middle thereof, and the attraction plate 30 corresponding to the positioning hole 41 has a spot-faced hole 35, and the positioning assembly 50A is a countersunk bolt 50A engaging into the spot-faced hole 35 to fix the attraction plate 30 to the mounted body 40. The mounted body 40 further has a pad 42 arranged between the bottom of the attraction plate 30 and the mounted body 40.

To test and verify the effectiveness of the present invention, the inventor uses the attraction plate of 185 mm×61 mm×12 mm to conduct the tensile test. The following table shows the attraction plate after being energized of 500 mA current, and 12V voltage.

| | | Tensile value | Increased rate |
|---|---|---|---|
| No. | Attraction surface | (pound) | of tensile value |
| 1 | NO convex-curve | About 1076 | — |
| | surface | | |
| 2 | convex-curve surface | About 1107 | 2.88% ↑ |
| | (h): 0.02 mm | | |
| 3 | convex-curve surface | About 1220 | 13.38% ↑ |
| | (h): 0.04 mm | | |
| 4 | convex-curve surface | About 1258 | 16.91% ↑ |
| | (h): 0.06 mm | | |
| 5 | convex-curve surface | About 1273 | 18.30% ↑ |
| | (h): 0.09 mm | | |
| 6 | convex-curve surface | About 1320 | 22.67% ↑ |
| | (h): 0.12 mm | | |
| 7 | convex-curve surface | About 1352 | 25.65% ↑ |
| | (h): 0.15 mm | | |
| 8 | convex-curve surface | About 1389 | 29.08% ↑ |
| | (h): 0.18 mm | | |
| 9 | convex-curve surface | About 1350 | 25.46% ↑ |
| | (h): 0.21 mm | | |
| 10 | convex-curve surface | About 1302 | 21.00% ↑ |
| | (h): 0.24 mm | | |
| 11 | convex-curve surface | About 1241 | 15.33% ↑ |
| | (h): 0.27 mm | | |
| 12 | convex-curve surface | About 1195 | ↓ |
| | (d): 0.29 mm | | |
| 13 | convex-curve surface | About 1070 | ↓ |
| | (h): 0.30 mm | | |

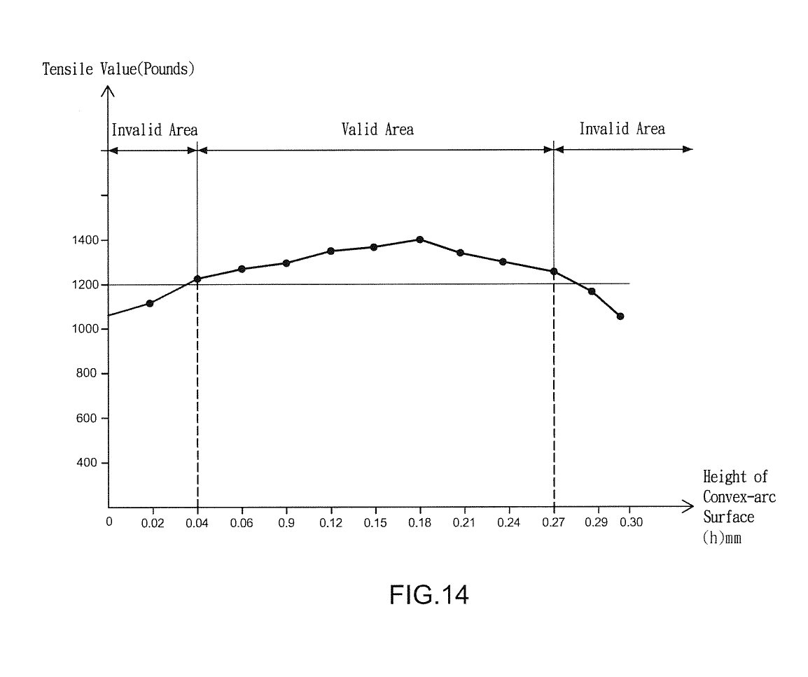

From the above test values, if the tensile position of attraction plate is set in the middle without the convex-curve surface 33 in the middle, the tensile value is about 1076 pounds. If the tensile position of attraction plate 30 is at the middle with the convex-curve surface 33 in the middle, there is no effect while the height h of the convex-curve surface 33 is within 0.04 mm; however, the tensile value is significantly increased between 0.04 mm to 0.27 mm. FIG. 14 is a curve diagram drew according to the present test, showing that the height h of the convex-curve surface 33 between 0.09 mm to 0.24 mm has the best tensile value. When the height h is over 0.27 mm, the curved internal stress will be too large to offset the attraction force of the electric magnet 20, decreasing the tensile force, and forming an invalid area. Therefore, from the above test values, the tensile value is increased about 13.38% to 29.08% according to the different height of the present invention.

The above test value uses the attraction plate of 185 mm×61 mm×12 mm; however, normal size of the attraction plate mostly has length from 180 to 200 mm, and thickness from 11 to 16 mm. Therefore, different attraction plate has different tensile value after test, but the corresponding increased rate of tensile value and the curve tendency diagram basically has little different. Thus, the attraction plate 30 under the same current, the tensile value of the electromagnetic doorlock is increased at least 10% to save energy and enhance the access control.

Although particular embodiments of the invention have been described in detail for purposes of illustration, various modifications and enhancements may be made without departing from the spirit and scope of the invention.

Accordingly, the invention is not to be limited except as by the appended claims.

What is claimed is:

1. An attraction plate structure of electromagnetic doorlock, comprising:
an electric magnet;
an attraction plate in a long shape, having an attraction surface, the attraction surface arranged at a corresponding surface of the electric magnet, and the attraction plate positioned on a mounted body by a positioning assembly; wherein
the attraction surface has an arch portion higher than the bottom plane of 0.04 mm to 0.27 mm at a central region thereof, and the arch portion extends towards both ends to form a curve surface, so that a convex-curve surface is formed with both ends lower than the central region;
whereby when the attraction plate is attracted by the magnetic force produced by the electric magnet, the convex-curve surface is forced to deform for abutting the electric magnet ; when the mounted body is pulled in an opposite direction of the electric magnet, the attraction plate under the tension of the positioning assembly overcomes the curved internal stress of the attraction plate to enhance the tensile value of the attraction plate.

2. The attraction plate structure of electromagnetic doorlock as claimed in claim 1, wherein the mounted body includes a box-like body, U-shaped body, L-shaped body, flat body, or door plate.

3. The attraction plate structure of electromagnetic doorlock as claimed in claim 2, wherein the mounted body has a positioning hole in middle thereof, and the attraction plate corresponding to the positioning hole has a spot-faced hole and the positioning assembly is a countersunk bolt engaging into the spot-faced hole to fix the attraction plate to the mounted body.

4. The attraction plate structure of electromagnetic doorlock as claimed in claim 3, wherein the mounted body further has a pad arranged between the bottom of the attraction plate and the mounted body.
